(19) United States
(12) Patent Application Publication
(10) Pub. No.: US 2004/0056533 A1
(43) Pub. Date: Mar. 25, 2004

(54) Power supply circuit

(76) Inventor: Chien-An Chen, Keelung (TW)

Correspondence Address: Michael D. Bednarek, Shaw Pittman LLP, 1650 Tysons Boulevard, McLean, VA, 22102, US

(21) Appl. No.: 10/659,328

(22) Filed: Sep. 11, 2003

(30) Foreign Application Priority Data
Sep. 24, 2002 (TW) 91121847

(51) Int. Cl. H02J 1/12

(52) U.S. Cl. 307/25

(57) ABSTRACT

The present invention provides a power supply circuit including a control circuit, a battery and two switches. When an electrical apparatus having the power supply circuit of the present invention is in a power saving mode, the control circuit receives a control signal and then sends respectively two signals to the switches. Therefore, the battery directly supplies a DC signal as a power resource to reduce power consumption.

This Application claims priority to Taiwan Patent Application No. 091121847 filed Sep. 24, 2002.

### FIELD OF INVENTION

The present invention relates to a power supply circuit of an electrical apparatus, such as projectors and LCD monitors. When the electrical apparatus switches to a power saving mode, a battery, instead of an AC/DC converter, is used as a DC power supply to reduce power consumption.

### BACKGROUND OF THE INVENTION

A power supply, indispensable for any electrical apparatus, is used to covert an alternating current (AC) signal transmitted from a power plant to a direct current (DC) signal which can be utilized by the electrical apparatus. As FIG. 1 shows, a conventional electrical apparatus 100 includes a power supply circuit 113 and an electrical device 117. An AC signal 101 flows into the power supply circuit 113 via an input terminal 103 and is converted to a DC signal 107 by an AC/DC converter 115 of the power supply circuit 113. The DC signal 107 is then outputted, via an output terminal 105, to the electrical device 117 as a power resource for use. However, there is always power consumption during the conversion. To pass the strict safety regulations, a conventional power supply circuit 113 needs to be re-designed to decrease the power consumption caused when the electrical apparatus 100 is in a power saving mode.

### SUMMARY OF THE INVENTION

The present invention provides a power supply circuit having a battery, an AC/DC converter, a control circuit and two switches. One switch is connected to an input terminal of the power supply circuit, the AC/DC converter and the control circuit. The other switch is connected to the battery, the control circuit and an output terminal of the power supply circuit. When going into a power saving mode, an electrical device connected to the power supply circuit of the present invention sends a control signal to inform the control circuit. After receiving the control signal, the control circuit respectively turns off the switch connected to the input terminal and turns on the switch connected to the battery. Accordingly, there is no AC signal allowed to flow into the AC/DC converter and the DC power of the electrical device is supplied by the battery.

### BRIEF DESCRIPTION OF THE DRAWINGS

The present invention will be clearly understood by referring to the detailed description as well as the attached figures:

FIG. 1 illustrates a power supply circuit of an electrical apparatus of the prior art;

FIG. 2 illustrates the power supply circuit of the present invention as the electrical apparatus is in a normal mode in accordance with the present invention; and

FIG. 3 illustrates the power supply circuit of the present invention as the electrical apparatus is in a power saving mode in accordance with the present invention.

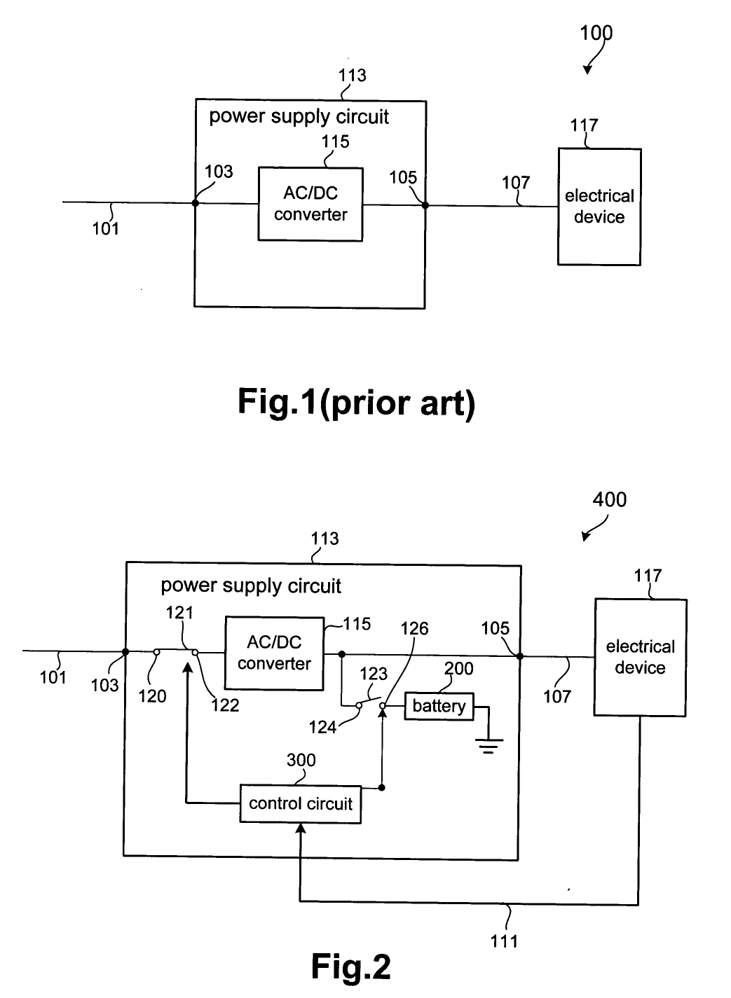

### DETAILED DESCRIPTION

The present invention provides an electrical apparatus with a power supply circuit and an electrical device. The power supply circuit is configured to selectively supply a first and a second DC signal inputted as a power resource to the electrical device. The electrical device is configured to execute specific function(s). As FIG. 2 shows, the power supply circuit 113 includes an input terminal 103, an output terminal 105, a first switch 121, a second switch 123, an AC/DC converter 115, a battery 200 and a control circuit 300. The input terminal 103 is configured to input an AC signal 101 transmitted from a power plant. The output terminal 105 is configured to selectively output a DC signal 107. The first switch 121 has a first end 120, which is connected to the input terminal 103, and a second end 122. The AC/DC converter 115 has an input terminal connected to the second end 122 of the first switch 121, and has an output terminal connected to the output terminal 105 of the power supply circuit 113. The second switch 123 has a first end 124, which is connected to the output terminal 105 of the power supply circuit 113, and a second end 126. The battery 200 is connected to the second end 126 of the second switch 123. The control circuit 300 is configured to control the first switch 121 and the second switch 123. When being in a normal mode, the electrical device 117 sends a first control signal 111 to the control circuit 300. In response to the first control signal 111, the control circuit 300 turns on the first switch 121 to electrically connect the input terminal 103 to the AC/DC converter 115, and also turns off the second switch 123 to electrically disconnect the battery 200 and the output terminal 105. Therefore, the AC signal 101 can flow inwards and then be converted to the first DC signal 107 by the AC/DC converter 115.

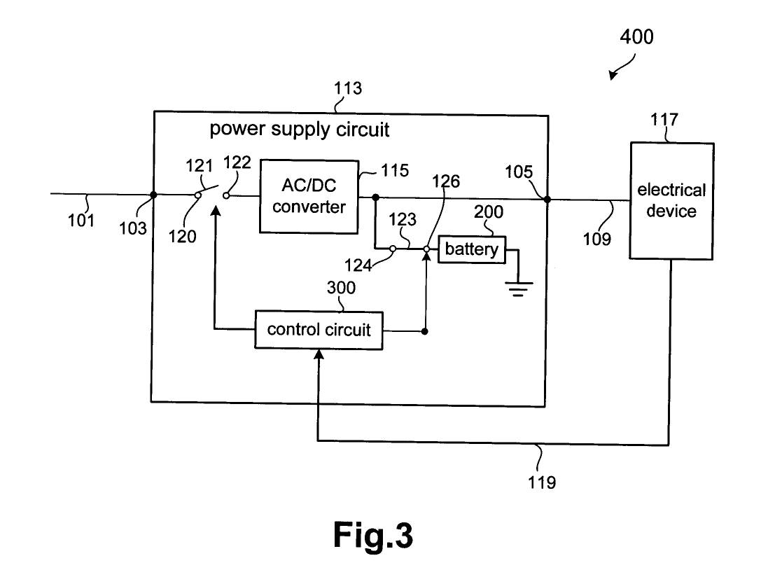

On the other hand, as FIG. 3 shows, when being in a particular mode, the electrical device 117 of an electrical apparatus 400 sends a second control signal 119 to the control circuit 300. In response to the second control signal 119, the control circuit 300 turns off the first switch 121 to electrically disconnect the input terminal 103 and the AC/DC converter 115, and also turns on the second switch 123 to electrically connect the battery 200 to the output terminal 105. Hence, the power resource of the electrical device 117 now switches to the second DC signal 109 supplied by the battery 200 to the output terminal 105 of the power supply circuit 113.

The electrical apparatus 400 in FIG. 3 may be a project or a monitor. When users stop using the electrical apparatus 400 for a while, the electrical apparatus 400 will enter a power saving mode automatically. The power consumption of the power saving mode is required to be low by safety regulations. When the control circuit 300 receives the second control signal 119, the battery 200 directly supplies the second DC signal 109 to the electrical device 117 without undesired power consumption generated by the AC/DC converter 115. Therefore, the aforementioned particular mode can be regarded as a power saving mode.

The above description of the preferred embodiments is expected to clearly expound the characteristics of the present invention but not expected to restrict the scope of the present invention. Those skilled in the art will readily observe that numerous modifications and alterations of the apparatus may be made while retaining the teaching of the invention. Accordingly, the above disclosure should be construed as limited only by the bounds of the claims.

1. A power supply circuit for selectively supplying a first and a second direct current (DC) signal inputted to an electrical device, the power supply circuit comprising:
an input terminal for inputting an alternating current (AC) signal;
an output terminal for selectively outputting the first and second DC signal;
a first switch having a first end and a second end, the first end being connected to the input terminal;
an AC/DC converter having an input terminal, connected to the second end of the first switch, and an output terminal, connected to the output terminal of the power supply circuit;
a second switch having a first end, connected to the output terminal of the power supply circuit, and a second end;
a battery connected to the second end of the second switch; and
a control circuit for controlling the first switch and the second switch;
wherein when the electrical device is in a normal mode, the control circuit turns on the first switch and turns off the second switch so that the AC/DC converter converts from the AC signal to the first DC signal, and when the electrical device is in a particular mode, the control circuit turns off the first switch and turns on the second switch so that the battery supplies the second DC signal to the output terminal of the power supply circuit.

2. The power supply circuit of claim 1, wherein the particular mode is a power saving mode.

3. An electrical apparatus comprising a power supply circuit, the power supply circuit comprising:
an input terminal for inputting an AC signal;
an output terminal for selectively outputting a first and a second DC signal;
a first switch having a first end, connected to the input terminal, and a second end;
an AC/DC converter having an input terminal, connected to the second end of the first switch, and an output terminal, connected to the output terminal of the power supply circuit;
a second switch;
a battery connected to the second switch; and
a control circuit for controlling the first switch and the second switch;
wherein when the electrical device is in a normal mode, the control circuit turns on the first switch and turns off the second switch so that the AC/DC converter converts from the AC signal to the first DC signal, and when the electrical device is in a particular mode, the control circuit turns off the first switch and turns on the second switch so that the battery supplies the second DC signal to the output terminal of the power supply circuit.

4. The electrical apparatus of claim 3, wherein the particular mode is a power saving mode.

5. The electrical apparatus of claim 3, wherein the electrical apparatus is a monitor.

6. The electrical apparatus of claim 3, wherein the electrical apparatus is a projector.
